(19) United States
(12) Patent Application Publication
(10) Pub. No.: US 2020/0196028 A1
(43) Pub. Date: Jun. 18, 2020

(54) VIDEO HIGHLIGHT RECOGNITION AND EXTRACTION TOOL

(71) Applicant: FocusVision Worldwide, Inc., New York, NY (US)

(72) Inventors: Michael H. Kuehne, JR., Stamford, CT (US); Marius A. Radu, Long Island, NY (US)

(21) Appl. No.: 16/568,448

(22) Filed: Sep. 12, 2019

Related U.S. Application Data
(60) Provisional application No. 62/779,268, filed on Dec. 13, 2018.

(51) Int. Cl. H04N 21/8549; G06F 16/738; H04N 21/845; G06N 3/08; H04N 21/81

(52) U.S. Cl. CPC H04N 21/8549; G06F 16/739; H04N 21/8126; G06N 3/08; H04N 21/8456

(57) ABSTRACT

A system including: at least one processor; and at least one memory having stored thereon instructions that, when executed by the at least one processor, control the at least one processor to: receive a video file; pre-process the video file to provide a timestamped transcript; sample across the timestamped transcript to generate a plurality of timestamped fragments; analyze the plurality of timestamped fragments to identify a likelihood of each fragment containing a highlight; extract, from the video file, a plurality of video clips corresponding to the fragments having a likelihood of containing a highlight greater than a threshold; and compile the plurality of video clips to generate a highlight video of the video file.

### CROSS-REFERENCE TO RELATED APPLICATIONS

This application claims priority to U.S. Provisional Patent Application Ser. No. 62/779,268, filed on Dec. 13, 2018, which is incorporated herein by reference in its entirety as if fully set forth below.

### FIELD OF THE DISCLOSURE

Embodiments of the present disclosure generally relate to video highlight recognition and extraction and, more particularly, to systems, tools and methods for recognition and extraction of highlights (e.g., key moments) from video and text data.

### BACKGROUND

Given the exponentially growing supply of data existing in our world, there has been an increased need for techniques that help human users sift through and find the most relevant content. This is especially true in the market research industry where large amounts of consumer research are conducted through video recordings (e.g., video interviews) and other mediums. Presently, human users manually review the vast majority of consumer video research to identify relevant portions (or highlights) of the recorded content. An average market research business case will have roughly 18 hours of video data, which in turn requires roughly 47 human user hours spent reviewing the data to identify highlights and prepare a highlight reel, which can be two minutes or less. To reiterate, on average, it can take 47-man hours to review 18 hours of video footage to make a 2-minute highlight reel.

### SUMMARY

Aspects of the disclosed technology relate to a robust tool that identifies and extracts highlights or key moments from video and text data. In particular, aspects of the present disclosure relate to a generalized natural-language processing, and highlight identification and extraction, tool including a long short-term memory, bi-directional neural network with an attention mechanism. According to some embodiments, the tool may be configured to analyze and decompose structured and unstructured text data into text sub-sets of high and low importance. The portions identified by the tool as “high importance” may be assumed to be of high interest to the readers, and thus may be characterized as highlights. In some embodiments, the tool may extract highlights from text data given a multi-factor configuration of parameters. These parameters may be tunable and can be thought of as features of the highlight extraction and generation itself. According to some embodiments, there may be four tunable parameters: automated keyword extraction, sentiment analysis, entity recognition, and human generated keywords.

One of the ansatzes guiding the inventors' work is that nearly all human-generated clip of data (e.g., video, audio, text, etc.) contains, at a minimum, some fragments of intrinsic value, which can be defined as a highlight. According to embodiments of the present disclosure, the highlight generation and extraction tool may incorporate one or more neural network models to assist in determining whether a fragment is indeed a highlight. These neural network models can be trained using datasets that include, for example, ten or more years' worth of focus groups, written reports, open ends, and online research. Additionally, these training datasets can be complemented by truth sets that can include user-generated fragments of text transcripts that were saved as clips. As will be appreciated, once the one or more neural network models have been trained on this data, the tool incorporating the one or more neural network models may function to identify portions of text or video data that human users are likely to select as important.

As will be appreciated, there may exist subjective differences among users as to what constitutes a highlight. According to some example embodiments, the results output by the tool may represent a statistical averaging over these personal opinions. In such embodiments, the tool can determine with high accuracy the likelihood that a fragment of text will be deemed “important” by a human user without having to clearly specify what constitutes “important.”

According to some example embodiments of the present disclosure, the highlight extraction and generation tool may gather user input and then use a feedback loop to update various parameters of the tool based on the gathered user input. As will be appreciated by one of skill in the art, over time, such a tool can evolve into a personalized highlight extraction tool for a set of users based on the feedback gathered from those users.

According to an embodiment, there is provided a system including: at least one processor; and at least one memory having stored thereon instructions that, when executed by the at least one processor, control the at least one processor to: pre-process a video file to provide a timestamped transcript; sample across the timestamped transcript to generate a plurality of timestamped fragments; analyze the plurality of timestamped fragments to identify a likelihood of each fragment containing a highlight; extract, from the video file, a plurality of video clips corresponding to the fragments having a likelihood of containing a highlight greater than a threshold; and compile the plurality of video clips to generate a highlight video of the video file.

Pre-processing the video file can include transcribing the video file with punctuation and stemming the transcription.

Sampling across the timestamped transcript can include sampling the timestamped transcript across minimum and maximum sentence count limits.

Sampling across the timestamped transcript can include applying at least from among a neural network to fragment the timestamped transcript, smart text fragmentation, boundary identification, beam search fragmentation, and peak extraction.

Analyzing the plurality of timestamped fragments can include applying a neural network to each timestamped fragment to generate respective likelihoods that each fragment contains a highlight.

The neural network can include a Long Short-term Memory model (LSTM) with attention.

Analyzing the plurality of timestamped fragments can further include cross-checking the fragments against designated attributes for desired highlights and identifying as highlights fragments that both have a high likelihood of containing a highlight and correspond to the designated attributes.

In an embodiment, only fragments identified as having a high likelihood of each containing a highlight are cross-checked against designated attributes.

In an embodiment, only fragments cross-checked against designated attributes are analyzed to determine whether they have a high likelihood of each containing a highlight.

Extracting the plurality of video clips can include: constructing a superset of highlights by merging overlapping identified fragments; and extracting the superset of highlights as the plurality of video clips.

Extracting the plurality of video clips can include performing boundary detection within the identified fragments and extracting, from the video file, a plurality of video clips corresponding to the fragments without crossing detected boundaries.

Receiving the video file can include retrieving the video file from a designated location.

Analyzing the plurality of timestamped fragments can include converting words within the timestamped fragments into embeddings.

According to an embodiment, these is provided a method including: pre-processing a video file to provide a timestamped transcript; sampling across the timestamped transcript to generate a plurality of timestamped fragments; analyzing the plurality of timestamped fragments to identify a likelihood of each fragment containing a highlight; extracting, from the video file, a plurality of video clips corresponding to the fragments having a likelihood of containing a highlight greater than a threshold; and compiling the plurality of video clips to generate a highlight video of the video file.

Pre-processing the video file can include transcribing the video file with punctuation and stemming the transcription.

Sampling across the timestamped transcript can include sampling the timestamped transcript across minimum and maximum sentence count limits.

Sampling across the timestamped transcript can include applying at least from among a neural network to fragment the timestamped transcript, smart text fragmentation, boundary identification, beam search fragmentation, and peak extraction.

Analyzing the plurality of timestamped fragments can include applying a neural network to each timestamped fragment to generate respective likelihoods that each fragment contains a highlight.

The neural network can include a Long Short-term Memory model (LSTM) with attention.

According to an embodiment, there is provided a non-transitory computer readable medium having stored thereon computer program code that, when executed by one or more processors, controls the one or more processors to execute a method including: pre-processing a video file to provide a timestamped transcript; sampling across the timestamped transcript to generate a plurality of timestamped fragments; analyzing the plurality of timestamped fragments to identify a likelihood of each fragment containing a highlight; extracting, from the video file, a plurality of video clips corresponding to the fragments having a likelihood of containing a highlight greater than a threshold; and compiling the plurality of video clips to generate a highlight video of the video file.

As will be appreciated, an advantage of aspects of the presently disclosed technology is the time savings it provides users by not having to manually review videos and their corresponding transcripts to identify highlights. As previously discussed, an average business case in the market research industry will have roughly 18 hours of video data, which requires roughly 47 human user hours of review time to identify and prepare highlights to be presented to a client. Embodiments of the present disclosure can reduce the time needed to identify and generate highlights by roughly 80%.

### BRIEF DESCRIPTION OF THE DRAWINGS

The accompanying drawings, which are incorporated in and constitute a part of this specification, illustrate multiple embodiments of the presently disclosed subject matter and serve to explain the principles of the presently disclosed subject matter. The drawings are not intended to limit the scope of the presently disclosed subject matter in any manner.

FIG. 1 is an example environment in which aspects of the present disclosure may be implemented according to an embodiment.

FIG. 2 is a flowchart of an example video identification and highlighting method according to an embodiment.

FIGS. 3-10 are examples of a graphical user interface(s) (GUI) associated a video highlight recognition and extraction tool, in accordance with embodiments of the present disclosure.

FIG. 11 is an example computer architecture that may be used to implement aspects of the present disclosure.

### DETAILED DESCRIPTION

In some embodiments, a video may be segmented, the segments may be analyzed using one or more neural networks, and highlights from the video may be automatically compiled. For example, an extraction tool may receive a video via a user upload. The extraction tool may transcribe the video into a timestamped text file (i.e., a timestamped transcript) or receive the transcription from an outside source. The tool may then perform statistical analysis on the timestamped text file and combine the results of the statistical analysis with user metadata to compute a unique set of parameters, S, which describe the data. Next, the tool can use the set of parameters, S, to determine how best to fragment the timestamped text file. For example, the tool may implement an adaptive sampling algorithm on the parameters, S, to create a set of document or text fragments (e.g., an exhaustive set).

The fragments are analyzed through a neural network, which scores each fragment based on a likelihood that the fragment includes a highlight. The tool then cross references the fragments having likely to include highlights against attributes of desired highlights (e.g., user defined attributes of a type of highlight). For example, a user may indicate a preference seeing highlights that illustrate a desired sentiment, such as a positive attitude toward a particular product, or highlights in which the subject's attitude toward the particular product is conveyed (e.g., positive or negative). To determine the sentiment of a given fragment, the tool can perform sentiment analysis by identifying and categorizing opinions expressed in a piece of text. Example implementations of the disclosed technology will now be described with reference to the accompanying figures.

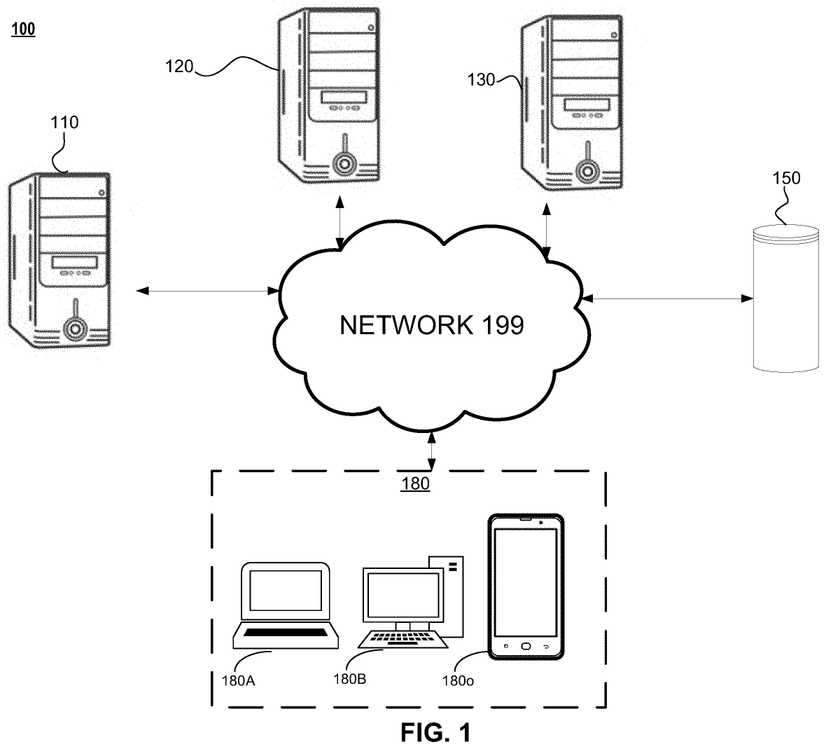

FIG. 1 illustrates an environment 100 in which aspects of the present disclosure may be implemented. Referring to FIG. 1, there is a preprocessing server 110, a highlight identification server 120, a highlight extraction server 130, a training database 150, and a user terminal 190. Preprocessing server 110, highlight identification server 120, highlight extraction server 130, training database 150, and user terminal 180 may communicate with one another, for example, over network 199. Preprocessing server 110, highlight identification server 120, highlight extraction server 130, training database 150, and user terminal 180 may each include one or more processors, memories, and/or transceivers. As non-limiting examples, user terminal 180 may be cell phones, smartphones, laptop computers, tablets, or other personal computing devices that include the ability to communicate on one or more different types of networks. Preprocessing server 110, highlight identification server 120, highlight extraction server 130, and/or training database 150 may include one or more physical or logical devices (e.g., servers, cloud servers, access points, etc.) or drives. Example computer architectures that may be used to implement Preprocessing server 110, highlight identification server 120, highlight extraction server 130, training database 150, and user terminal 180 are described below with reference to FIG. [[5]]. Although preprocessing server 110, highlight identification server 120, highlight extraction server 130, training database 150, and user terminal 180 are illustrated and described as distinct devices, one of ordinary skill will recognize in light of the present disclosure, that the functionality of preprocessing server 110, highlight identification server 120, highlight extraction server 130, training database 150, and user terminal 180 may be combined in one or more physical or logical devices.

Preprocessing server 110 can receive a video from user terminal 180. For example, user terminal 180 can transmit the video to preprocessing server 110 (e.g., over network 199) or provide a location (e.g., a web address) and preprocessing server 110 can retrieve the video from the provided location. Preprocessing server 110 can transcribe the video into a timestamped text file. The timestamped text file can include punctuation. During development, the inventors were surprised to find that including punctuation into the test file greatly improved highlight identification performance far above expectations when combined with other aspects of this disclosure. In an embodiment, properly identifying and categorizing the punctuation of a transcript uses a specialized program to differentiate between punctuation uses (e.g., periods at an end of a sentence versus periods within a sentence, such as in the terms “Ph.D.” or “Mr.”). Preprocessing server 110 may stem the timestamped text file by removing the ends of certain words. One of ordinary skill will recognize various techniques capable of stemming text files. This is a normalization technique which is like removing noise, making the dataset smoother. Although the inventors expected any gains from stemming to be small, stemming provided the greatest improvement of stemming among normalization techniques. Once the timestamped text file is created, preprocessing server 110 may transmit the timestamped text file to highlight identification server 120.

Highlight identification server 120 can receive the timestamped text file from preprocessing server 110 and/or user terminal 180 (e.g., if the timestamped text file has been already created). Highlight identification server 120 can fragment the text file into a series of document samples. For example, highlight identification server 120 can implement adaptive sampling algorithm on the parameters, S to create a set of document or text fragments (e.g., an exhaustive set). The parameters may include, for example, a weighting for length of samples (e.g., longer highlights preferred), preference for complete sentences, and processing time requirements (as more overlapping samples creates additional overhead). In an embodiment, the parameters may additionally or alternatively include one or more of: i) highlight score, ii) highlight score and length of fragment iii) highlight score and a fixed fragment length (e.g., one sentence), and/or iv) a mean field approach where all the h-scores were averaged and the region of highest density was singled out for highlight extraction. The parameters may be provided, for example, from user terminal 180. For example, highlight identification server 120 can sample the timestamped text file across minimum and maximum sentence and word count limits to provide timestamped fragments. However, this is merely an example, and, in light of the present disclosure, one of ordinary skill will recognize additional sampling methods may be used, such as category-specific fragmentation algorithm, the use of a standalone model to identify boundaries in the data (e.g., scene or topic changes), smart text fragmentation (e.g., based on topic model or key phrases), beam search fragmentation (e.g., segments document in-to non-overlapping fragments based on a beam search with a set range which can reduce the number of fragments sampled by discarding portions with a low start score), and peak extraction (e.g., based on some variety of fixed segment averaging: evaluate h-score by sentence, plot as a function of time, and extract peaks).

Once the text fragments are created, highlight identification server 120 can convert the fragments into embeddings or other vectors. As will be understood by one of ordinary skill in light of the present disclosure, embeddings is a manner of converting words into numbers. Thereafter, mathematical relationships between words may be determined. Given a sentence with words wᵢⱼ,t∈[0,T], highlight identification server 120 can transform the words into vectors via an embedding matrix Wₑ such that vᵢⱼ=Wₑwᵢⱼ. In some cases, highlight identification server 120 can train matrix Wₑ in conjunction with a neural language model. In some cases, matrix Wₑ may utilize pre-trained weights. One advantage of using embeddings is the ability to capture similarity between words the model may have never seen. Embeddings provide a dense representation of words by a non-orthogonal set of latent vectors typically of much lower dimension than bag-of-words and bag of N-grams models. The inventors surprisingly discovered that, combined with aspects of the present disclosure, embeddings performs on par with count vectorization (CV) and term frequency-inverse document frequency (TFIDF). The result was particularly surprising given that the dimensionality of the embeddings may be 2-3 orders of magnitude smaller than the dimensionality of CV or TFIDF. Additionally, inventors surprisingly found that TFIDF may not outperform CV when combined with aspects of the present disclosure. As one of ordinary skill will recognize, this result is surprising because typically TFIDF features are generally accepted to out-perform word count (CV) features. This is because TFIDF weights common words less than rare words. Converting the fragments into embeddings or other vectors greatly improves the overall quality of the highlight identification.

Highlight identification server 120 can analyze the text fragments (or converted fragments) through a neural network (e.g., a Long Short-term Memory model (LSTM) or other recursive neural network (RNN)), which scores each fragment based on a likelihood that the fragment includes a highlight. But an issue with the related art is that the classification scheme of the data model is binary (i.e., highlight or non-highlight). To construct a continuous model, the granularity of the two-class (highlight vs. non-highlight) scheme must be reduced to that of an infinite-class, which can be done by forcing the final output of the neural network to be a probability distribution over the two classes. In an embodiment, this is accomplished by adding a SoftMax layer as the last layer of the Neural Network, which can force the outcome to be a probability distribution. Thus, the output of the neural network may be considered an h-score (highlight score) indicating the likelihood of a given fragment corresponding to a highlight.

One of ordinary skill will recognize that bidirectional RNNs are better suited at solving certain problems. During experimentation, inventors surprising found that improvement from using a bi-directional RNN over a unidirectional RNN was minimal in light of the additional processing time and cost to train. Accordingly, in an embodiment, unidirectional RNNs are used to analyze the text fragments. Additionally, unexpectedly, attention did not increase the performance of the classifiers. However, the use of attention surprisingly greatly reduced the training time required by the neural network by almost an order of magnitude. For example, without attention. an average of 5-10 epochs was for model improvement to plateau; however, with attention an average 2-3 epochs were required. This is extremely significant especially in an embodiment where model retraining is needed. Accordingly, to optimize training time, an embodiment utilizes attention with RNN, and, particularly, an embodiment utilizes LSTM with attention. As will be understood by one of ordinary skill, in a related art LSTM method, a hidden vector is multiplied with every embedded word sequentially, and at the end of the sequence this hidden vector is used to make a prediction about the fragment of text in question. Thus, a single hidden vector determines the fate of the entire fragment. In an embodiment, LSTM with attention no longer uses a single hidden vector, but multiple ones (e.g., one for every word). In this manner aspects of the present disclosure pay “attention” to which hidden vectors contribute the most to the prediction, and consequently, which words has the most impact when determining whether the fragment is a highlight. In some cases, training database 150 may store video training material for the neural network and/or the trained neural network.

Once highlight identification server 120 processes all the fragments, each fragment will have a highlight likelihood associated with it. Highlight identification server 120 then analyzes potential highlights based on attributes for desired highlights. In some cases, highlight identification server 120 may not further analyze any fragments having a less than threshold prediction (e.g., 50%) of being a highlight. The attributes may include one or more from among a sentiment (positive or negative) or viewpoint of a particular product, topic, or other item of interest, highlight length, word count, entities and/or key phrases (e.g., presence of a specific time, dollar value, name, brand name, location, objectivity, key-word and/or synonyms, etc.). To determine the sentiment of a given fragment, highlight identification server 120 can perform sentiment analysis by identifying and categorizing opinions expressed in a piece of text (i.e., the fragment). Highlight identification server 120 then notifies highlight extraction server 130 of the identified highlights.

Highlight extraction server 130 can receive the identified highlights (e.g., information indicating where in the video and/or transcript the identified highlights occur) sand extract highlights from the video. As highlights may overlap, highlight extraction server constructs a superset of highlights that removes the overlapping portions. For example, consider a video is broken into 10 fragments (1-10) with each fragment overlapping its neighbors (e.g., fragment 1 overlaps fragment 2 and fragment 2 overlaps fragments 1 and 3). If highlight identification server identified fragments 2, 6, and 7 as highlights, highlight extraction server 130 may extract the corresponding video clips from the video for fragments 2, 6, and 7, but only extract the overlapping portion of fragments 6 and 7 once (e.g., as a single clip). In some cases, an extracted clip of overlapping highlights may be stamped or otherwise apportioned such that one or both of the clips may be selectively viewed. One of ordinary skill will recognize in light of the present disclosure that there are multiple features to highlight creation which the user can have control over (e.g., groupings can be made in a multitude of ways depending on the needs of the user). Highlight extraction server 130 can send the extracted highlights to user terminal 180 through network 199.

In some cases, highlight extraction server 130 can perform additional analysis before extracting the highlights. For example, highlight extraction server 130 can implement a standalone model to identify boundaries (e.g., scene or topic changes) within the identified fragments and tailor highlight extraction accordingly.

By utilizing unique techniques and unique combinations of techniques as described in aspects of the present disclosure, the inventors were able to atomically generate highlight videos with over 94% accuracy. With this level of accuracy, an embodiment may over-sample highlights which can all provided to a user of user terminal 180 for verification and selection.

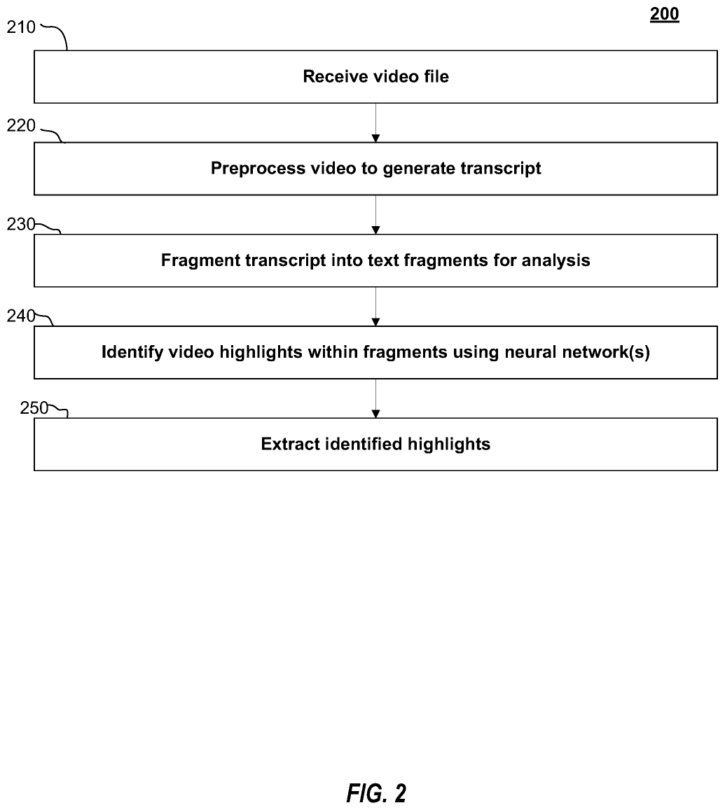

FIG. 2 is a flow chart of a method 200 of highlight identification and extraction. The method 200 of FIG. 2 may be performed, for example, by one or more of preprocessing server 110, a highlight identification server 120, a highlight extraction server 130 (e.g., a highlight identification and extraction tool). Referring to FIG. 2, the tool receives 210 a video file. For example, preprocessing server 110 may receive the video from user terminal 180. In some cases, the tool (e.g., preprocessing server 110) may receive a location (e.g., a web address or database access information) and retrieve the video from the provided location.

The tool then preprocesses 220 the video. For example, the tool (e.g., preprocessing server 110) can transcribe the video into a timestamped text file. In some cases, the timestamped text file can be provided to the tool (e.g., from user terminal 180). Transcribing the video can include providing punctuation within the transcript and/or stemming the words of the transcript.

Once the timestamped text file is created, the tool (e.g., highlight identification server 120) samples 230 the transcript into a plurality of text fragments. For example, highlight identification server 120 can perform adaptive sampling on the parameters, S to create a set of document or text fragments (e.g., an exhaustive set). For example, highlight identification server 120 can adaptively sample 230 the transcript based on parameters (e.g., provided by user terminal 180). Once the text fragments are created, highlight identification server 120 can convert the fragments into embeddings or other vectors.

Next, the tool (e.g., highlight identification server 120) identifies 240 highlights within the video. Highlight identification server 120 can analyze the text fragments (or converted fragments) through a neural network, and score each fragment based on a likelihood that the fragment includes a highlight. Once all fragments are analyzed with the neural network, each fragment will have assigned a highlight likelihood score (e.g., an h-score). The tool than analyzes the fragments based on attributes for desired highlights (e.g., cross references the fragments against attributes of desired highlights). The fragments with matching attributes and high h-scores are identified 240 as the highlights.

Finally, the tool (e.g., highlight extraction server 130) extracts 250 the identified highlights from the video. As highlights may overlap, highlight extraction server constructs a superset of highlights that removes the overlapping portions. In some cases, the tool may stamp or otherwise annotate extracted clip(s). Additionally, the tool (e.g., highlight extraction server 130) can identify boundaries (e.g., scene or topic changes) or other conditions within designated fragments and tailor highlight extraction accordingly (e.g., but cutting a highlight shorter than the fragment if an abrupt scene change occurs within the fragment).

Although highlight identification and extraction are discussed with reference to transcript analysis, this is merely an example. In an embodiment, video analysis (e.g., identification of highlights based on video features such as object ID, statistical measures of colors, hues, and scene changes) and/or audio analysis (e.g., identification of highlights based on audio features such as MFCC features) may be used in addition to or instead of transcript analysis.

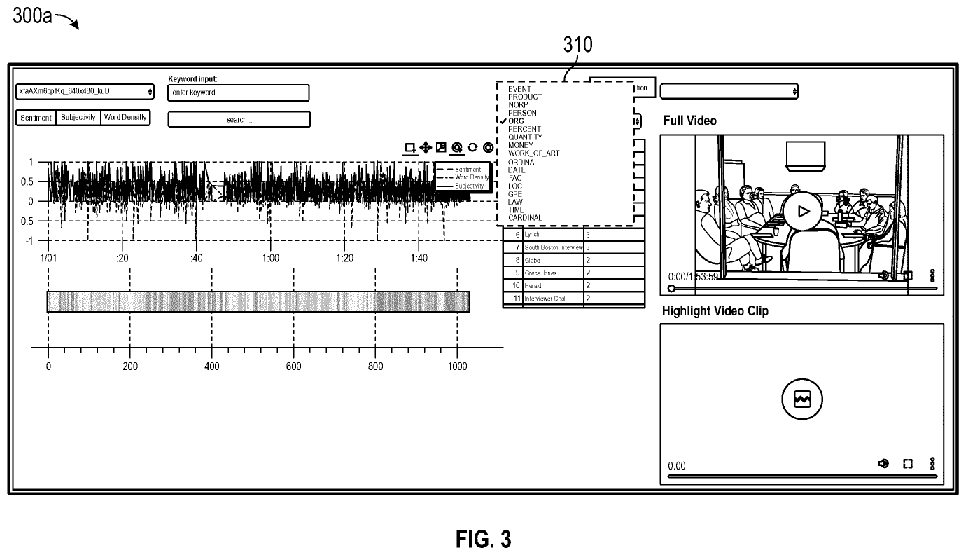

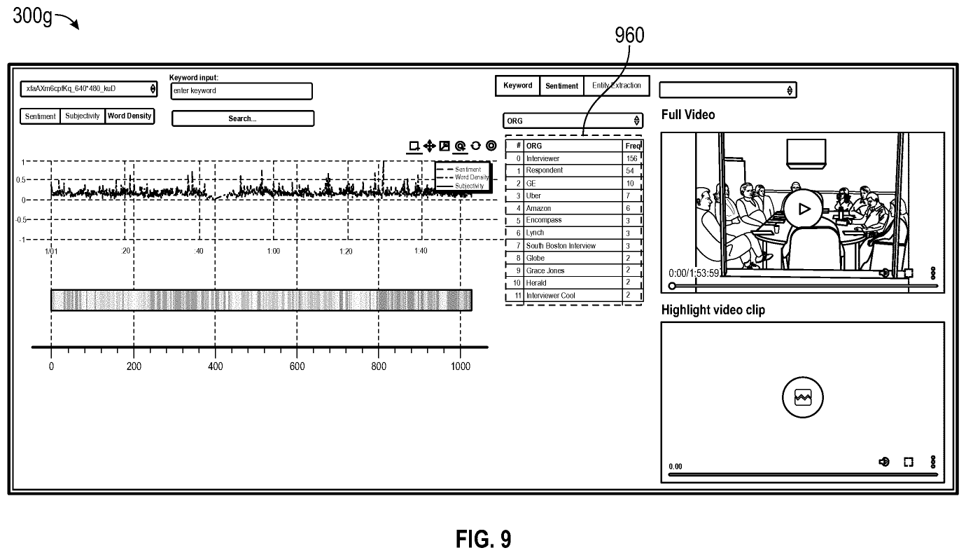

FIGS. 3-10 illustrate example GUIs 300a-300h of a user interface according to an embodiment. In FIG. 3, GUI 300a includes an example entity extraction selection list 310. The entity extraction selection list 310 may provide a listing of named entities (e.g., organizations, people, products) recognized within the video (e.g., transcripts). The listing can be used to cross-reference high-scoring highlight fragments with entities (e.g., if a user is interested in such a grouping and/or report). In FIG. 9, GUI 300g displays the results 960 of an “ORG” (e.g., organization) entity extraction. As can be seen, a list of entities discussed in the video is provided and listed based on frequency, though this is merely an example.

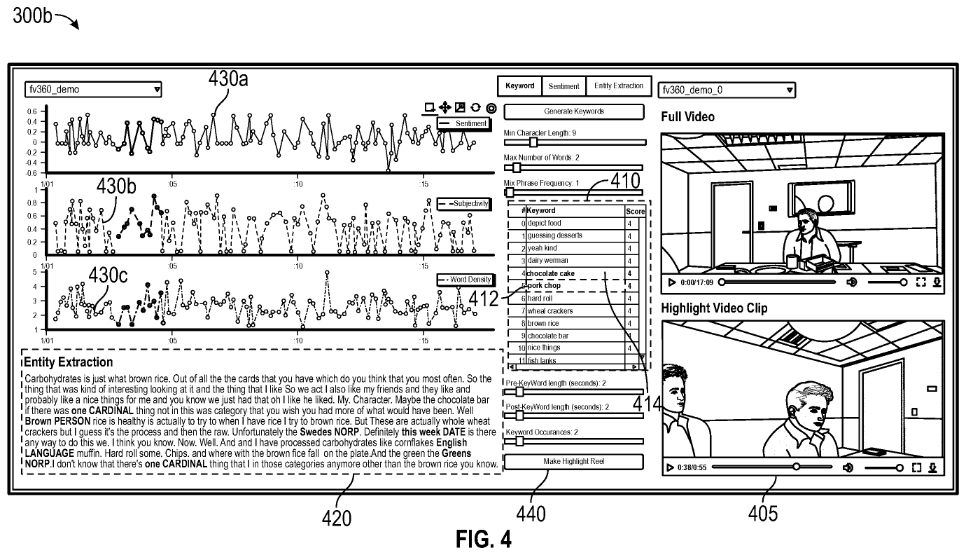

As shown in FIG. 4, GUI 300b illustrates a highlight reel 405 provided based on a selection of keywords 412 and 414 from a keyword list 410. The keyword list 410 may be generated by, for example, highlight identification server 120. A transcript 420 of the highlight video may displayed on the GUI 300b. GUI 300b further includes depicts graphs of sentiment 430a, subjectivity 430b and word density 430c in the upper left portion of the image. The transcript 420 and/or graphs 430a-430c may adjust in real-time to reflect the corresponding statements and/or graphs of currently played portions of a video (e.g., highlight reel 405). The highlight real may be generated in response to a user selection of the “Make Highlight Reel” button 440.

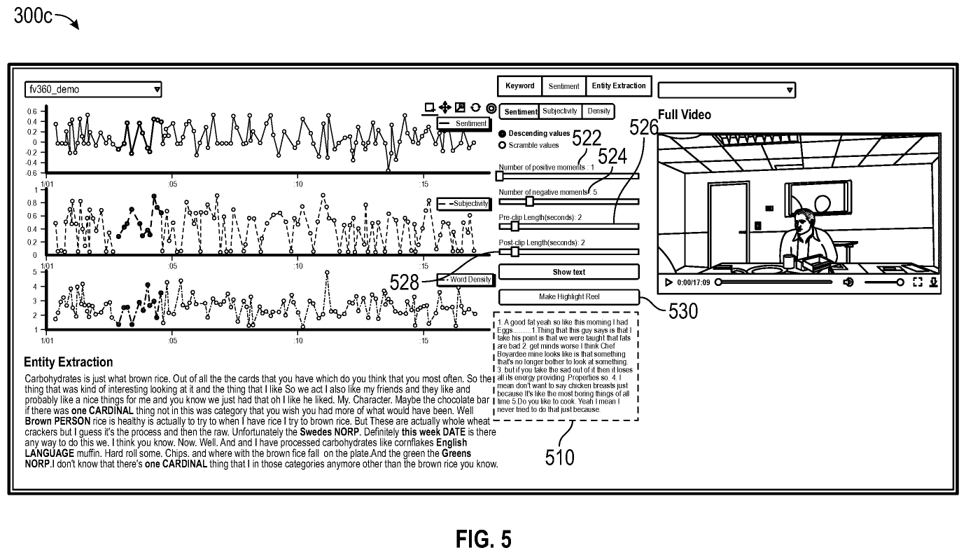

FIG. 5 illustrates GUI 300c depicts transcripts 510 corresponding to particular “Sentiments.” As depicted, the user may select the number of positive and/or negative moments 522 and 524, along with pre- and post-clip trim length 526 and 528. By selecting the “Show Text” button 530, the transcripts 510 of the potential may be displayed before the corresponding fragment(s) is turned into a highlight reel.

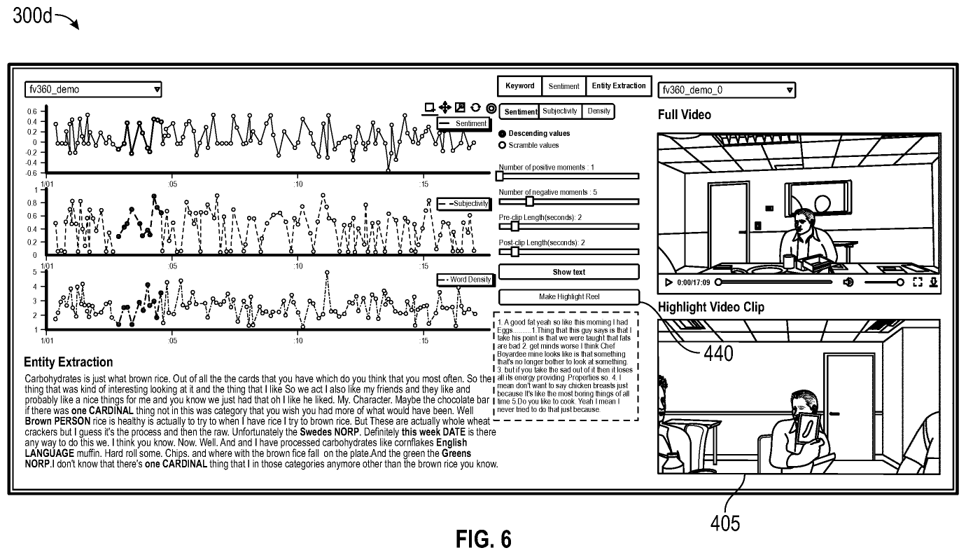

FIG. 6 illustrates a GUI 300d similar to FIG. 5 except a user has selected the “Make a Highlight Reel” button 440. In response, a highlight reel 405 was generated and displayed on GUI 600d.

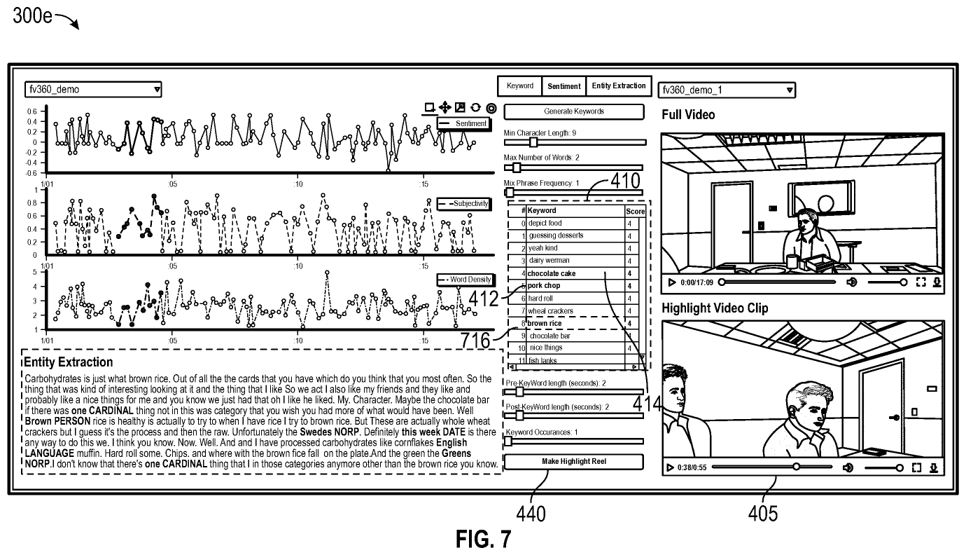

In FIG. 7, GUI 300e displays a highlight reel 405 generated based on keywords. Further, as shown, the user has selected three keywords (i.e., 412, 414, and 716) from the drop-down list 410 of keywords and has clicked “Make Highlight Reel” 440. Responsive to the user's selections, a highlight reel 405 can be generated and displayed based on the selected keywords. Additionally, the

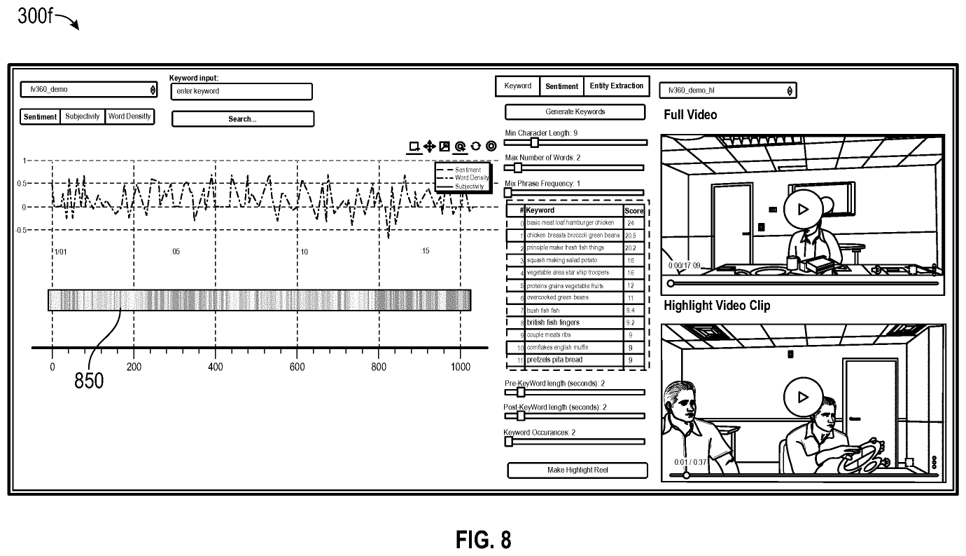

FIG. 8 illustrates is a GUI 300f with graphically displayed speaker identification. As shown in the bottom left portion of the image, the bar graph 850 depicts the speaker identification at a specific point in the video based on different colors/shades. Speakers may be identified, for example, through speaker diarization, which is based on Hidden Markov Models. As will be understood by one of ordinary skill in light of the present disclosure, speaker diarization is an audio based process which analyzes all the voices on the track and determines from whom each voice originates.

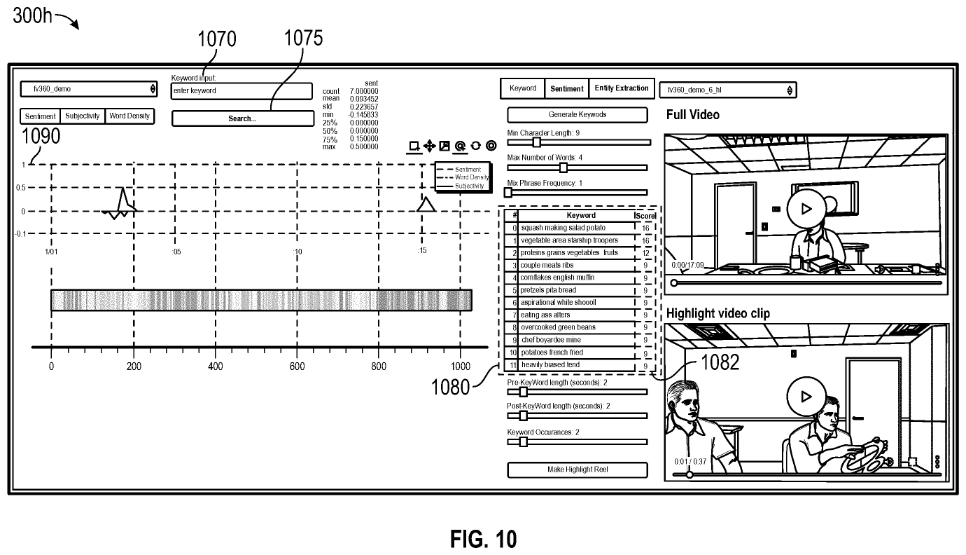

In FIG. 10, GUI 300h includes a display of keywords 1080 based on user input search terms overlaid with sentiment scores 1082. In the depicted example, the user enters “carb” into the “Keyword input” box 1070 in the upper left portion of the image and then selects the green “Search” button 1075. The graph 1090, depicted below the search box 1070, indicates where in the transcript “carb” occurs and if it occurs with positive (greater than 0) or negative (less than 0) sentiment.

In some embodiments, a tool can be configured to complete two functions: (1) highlight recognition and (2) highlight extraction. As will be understood by one of ordinary skill in light of the present disclosure, highlight recognition is the process by which the probability that a short snippet of data (−N sentences of text) is a highlight is determined. In some embodiments, to compute this probability, the tool may embed the text into a numerical vector and send the numerical vector through one or more neural network models that produce as an output a single value between −1 and 1. In such an embodiment, the more positive the value (i.e., the closer to 1), the higher the likelihood that the sampled data may represent a highlight. As will be understood by one of ordinary skill in light of the present disclosure, highlight extraction, can consist of using adaptive sampling techniques to segment a large body of data (much larger than N sentences of text data) into fragments. According to some embodiments, the tool can have built-in logic to determine the most efficient way to segment a given document or other data source. In some embodiments of the present disclosure, after segmenting the given document, the tool can evaluate the segments with the neural network and score them as described herein with a resulting output value being from −1 to 1. In such an embodiment, the tool may extract and/or consolidate the highest scoring fragments to the user according to any received user parameters or preferences.

The following example use cases describes an example flow pattern wherein a tool of the present disclosure receives and processes data. These examples are provided solely for explanatory purposes and not in limitation. First, the tool may receive a video via a user upload. The tool may then transcribe the video into a timestamped text file, though in some embodiments, the tool may receive pre-transcribed video data (i.e., the transcription may be outsourced). The tool may then perform statistical analysis on the timestamped text file and may combine the results of the statistical analysis with user metadata to compute a unique set of parameters, S, which describe the data. Next, the tool can use the set of parameters, S, to determine how best to fragment the timestamped text file. In some embodiments, the parameters, S, may be used the input to an adaptive sampling algorithm which returns as output an exhaustive set of document or text fragments. As will be appreciated, various factors can influence how best to fragment the timestamped text file depending on the needs of the user. For example, some users may value time over accuracy, and may tolerate a tradeoff between accuracy and speed. Other users may place a premium on accuracy and therefore may tolerate longer processing times.

Once the tool fragments the data, it can then pass the fragments through a neural network, which will score each fragment as previously described. Responsive to scoring each fragment, the tool may drop all fragments with a negative score from the dataset before performing any further processing. The tool may then cross reference the fragments having a positive score with additional user input that describes the nature of the user's desired highlights. For example, a user may indicate a preference seeing highlights that illustrate a desired sentiment. For instance, a user may indicate that they only want highlights where the subject projects a positive attitude toward a particular topic, product, etc. Alternatively, or additionally, a user may indicate a desire to see only highlights in which the subject's attitude toward a particular topic, product, etc., is negative (or indifferent).

To determine the sentiment of a highlight, the tool may employ sentiment analysis, which is the process of computationally identifying and categorizing opinions expressed in a piece of text, especially to determine whether the subject's attitude toward a particular topic, product, etc., is positive, negative, or neutral.

As another example, a user may indicate a desire for highlights that focus on a particular named entity or brand name. To meet the user's needs, the tool may employ name entity extraction or a process for recognizing named entities. Accordingly, the tool may identify named text figures (e.g., people, places, organizations, products, and brands). In some embodiments, the tool may identify names of trading stocks, specific abbreviations, even specific strains of a disease can be identified and tagged as an entity.

Additionally, a user may indicate a desire for highlights that focus on one or more themes or categories. To separate highlights according to theme and category, the tool may employ comprehensive text analysis that relies on contextual clues. As will be appreciated, contextual clues can be particularly important when dealing with words that have multiple meanings, such as the word crane, which could refer to a machine used to lift heavy objects, a type of bird, or even a movement of someone's neck. Whereas, the tool can be configured to automatically extract themes, categories may need to be preconfigured ahead of time. In some embodiments, the tool can determine relevant categories based on user input. In other embodiments, the tool can receive category designations from the user. As an example relating to a retail establishment, a user might be interested in categories such as staff, location, parking, stock availability, lighting, or pricing, among others. As will be understood by one of skill in the art, various categories and types of categories can be provided according to the business types and needs of particular users.

In addition to the previously described user preferences, users also may specify certain keywords they wish to appear in the highlights that they wish to receive. In such cases, the tool may be able to generate specific keywords that should show up in all highlights to be sent to the user. Additionally, system users can specify a maximum highlight length, according to some embodiments.

After the tool has cross referenced the segments having positive scores with the user input, the tool may initiate a search function to ensure that: (1) the results to be presented will match user specifications, (2) the highlight results will not contain redundancies, (3) the highlight results do not contain any corrupt data, and (4) there is one-to-one correspondence between the highlights in the video data and the timestamped text file. The tool may then segment the segments having positive scores into a subset of highlights that corresponds to the user's inputs to be presented to the user. For example, if user specified a specific brand name (e.g., Brand X) and selected to only receive “negative” sentiment scores, the tool will only return a set of highlights having negative sentiment that involve the brand Brand X. To generate video clips corresponding to this set of highlights, using timestamps in the text data, the tool can match the text of this set of highlights with the corresponding video metadata. The tool may then aggregate these video highlights and arrange them into a reel. In some embodiments, the highlight video clips may be arranged chronologically, but they can also be arranged based on the relative scores. After the clips are aggregated into a highlight reel, the too may present the reel to the user.

In addition to this specification and the prepared drawings, this disclosure includes an appendix detailing the development of a tool in accordance with the present disclosure. It is intended solely for explanatory purposes and not in limitation.

As will be understood, the present disclosure presents several advantages over related art systems. First, the disclosed tool provides for automatic extraction of important moments from videos/text corpora. Further, this tool applies techniques typically associated with increasing the static value of text-based data to identify highlights within text or video. In addition, the present disclosure provides the following advantages: the linkage of text analysis of transcript to video file, clip creation of video file using keyword/phrase as anchor, and arrangement of video clips created by timestamp rather than text analysis intensity.

Additionally, the tool as disclosed presents advantages of adaptive or random sampling of inputs into a neural model. Such sampling departs from convention methods of linearly feeding an input into a neural model. In some embodiments of the present disclosure, the adaptive sampling methods allow for more sampling than a traditional linear model, thus increasing the likelihood of recognizing all relevant highlights.

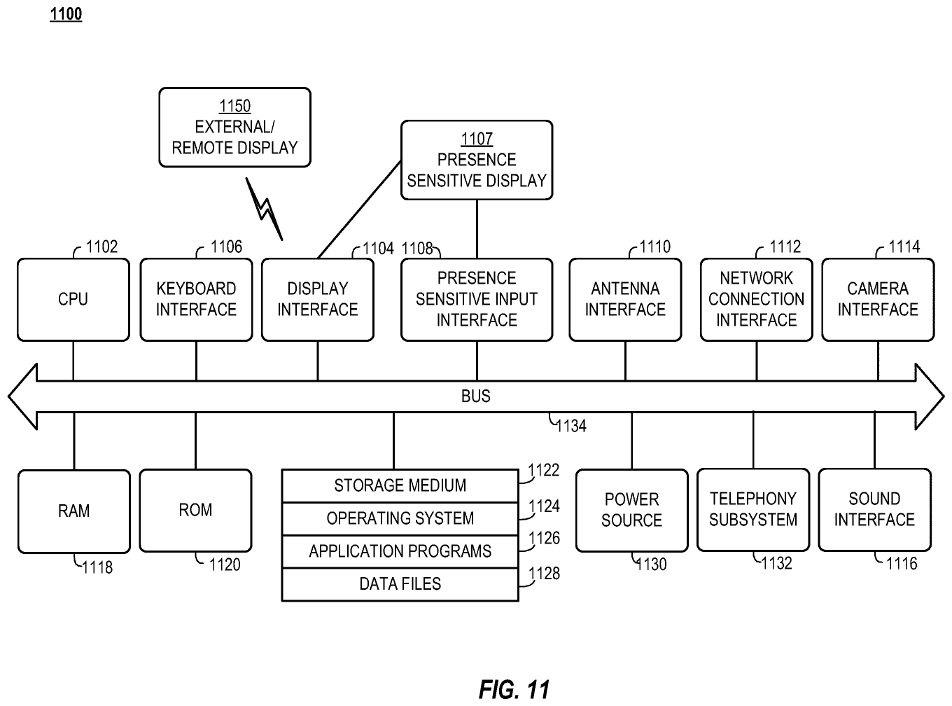

As desired, implementations of the disclosed technology may include a computing device, such as preprocessing server 110, highlight identification server 120, highlight extraction server 130, training database 150, and user terminal 180 with more or less of the components illustrated in FIG. 11. The computing device architecture 1100 is provided for example purposes only and does not limit the scope of the various implementations of the present disclosed computing systems, methods, and computer-readable mediums.

The computing device architecture 1100 of FIG. 11 includes a central processing unit (CPU) 1102, where executable computer instructions are processed; a display interface 1104 that supports a graphical user interface and provides functions for rendering video, graphics, images, and texts on the display. In certain example implementations of the disclosed technology, the display interface 1104 connects directly to a local display, such as a touch-screen display associated with a mobile computing device. In another example implementation, the display interface 1104 provides data, images, and other information for an external/remote display 1150 that is not necessarily physically connected to the mobile computing device. For example, a desktop monitor can mirror graphics and other information presented on a mobile computing device. In certain example implementations, the display interface 1104 wirelessly communicates, for example, via a Wi-Fi channel or other available network connection interface 1112 to the external/remote display.

In an example implementation, the network connection interface 1112 can be configured as a wired or wireless communication interface and can provide functions for rendering video, graphics, images, text, other information, or any combination thereof on the display. In one example, a communication interface can include a serial port, a parallel port, a general purpose input and output (GPIO) port, a game port, a universal serial bus (USB), a micro-USB port, a high definition multimedia (HDMI) port, a video port, an audio port, a Bluetooth port, a near-field communication (NFC) port, another like communication interface, or any combination thereof.

The computing device architecture 1100 can include a keyboard interface 1106 that provides a communication interface to a physical or virtual keyboard. In one example implementation, the computing device architecture 1100 includes a presence-sensitive display interface 1108 for connecting to a presence-sensitive display 1107. According to certain example implementations of the disclosed technology, the presence-sensitive input interface 1108 provides a communication interface to various devices such as a pointing device, a capacitive touch screen, a resistive touch screen, a touchpad, a depth camera, etc. which may or may not be integrated with a display.

The computing device architecture 1100 can be configured to use one or more input components via one or more of input/output interfaces (for example, the keyboard interface 1106, the display interface 1104, the presence-sensitive input interface 1108, network connection interface 1112, camera interface 1114, sound interface 1116, etc.) to allow the computing device architecture 1100 to present information to a user and capture information from a device's environment including instructions from the device's user. The input components can include a mouse, a trackball, a directional pad, a track pad, a touch-verified track pad, a presence-sensitive track pad, a presence-sensitive display, a scroll wheel, a digital camera including an adjustable lens, a digital video camera, a web camera, a microphone, a sensor, a smartcard, and the like. Additionally, an input component can be integrated with the computing device architecture 1100 or can be a separate device. As additional examples, input components can include an accelerometer, a magnetometer, a digital camera, a microphone, and an optical sensor.

Example implementations of the computing device architecture 1100 can include an antenna interface 1110 that provides a communication interface to an antenna; a network connection interface 1112 can support a wireless communication interface to a network. As mentioned above, the display interface 1104 can be in communication with the network connection interface 1112, for example, to provide information for display on a remote display that is not directly connected or attached to the system. In certain implementations, a camera interface 1114 is provided that acts as a communication interface and provides functions for capturing digital images from a camera. In certain implementations, a sound interface 1116 is provided as a communication interface for converting sound into electrical signals using a microphone and for converting electrical signals into sound using a speaker. According to example implementations, a random access memory (RAM) 1118 is provided, where executable computer instructions and data can be stored in a volatile memory device for processing by the CPU 1102.

According to an example implementation, the computing device architecture 1100 includes a read-only memory (ROM) 1120 where invariant low-level system code or data for basic system functions such as basic input and output (I/O), startup, or reception of keystrokes from a keyboard are stored in a non-volatile memory device. According to an example implementation, the computing device architecture 1100 includes a storage medium 1122 or other suitable type of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), for storing files include an operating system 1124, application programs 1126 (including, for example, a web browser application, a widget or gadget engine, and or other applications, as necessary), and data files 1128. According to an example implementation, the computing device architecture 1100 includes a power source 1130 that provides an appropriate alternating current (AC) or direct current (DC) to power components.

According to an example implementation, the computing device architecture 1100 includes a telephony subsystem 1132 that allows the device 1100 to transmit and receive audio and data information over a telephone network. Although shown as a separate subsystem, the telephony subsystem 1132 may be implemented as part of the network connection interface 1112. The constituent components and the CPU 1102 communicate with each other over a bus 1134.

According to an example implementation, the CPU 1102 has appropriate structure to be a computer processor. In one arrangement, the CPU 1102 includes more than one processing unit. The RAM 1118 interfaces with the computer bus 1134 to provide quick RAM storage to the CPU 1102 during the execution of software programs such as the operating system, application programs, and device drivers. More specifically, the CPU 1102 loads computer-executable process steps from the storage medium 1122 or other media into a field of the RAM 1118 in order to execute software programs. Data can be stored in the RAM 1118, where the data can be accessed by the computer CPU 1102 during execution. In one example configuration, the device architecture 1100 includes at least 1128 MB of RAM, and 256 MB of flash memory.

The storage medium 1122 itself can include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow a computing device to access computer-executable process steps, application programs and the like, stored on removable and non-removable memory media, to off-load data from the device or to upload data onto the device. A computer program product, such as one utilizing a communication system, can be tangibly embodied in storage medium 1122, which can include a machine-readable storage medium.

According to one example implementation, the term computing device, as used herein, can be a CPU, or conceptualized as a CPU (for example, the CPU 1102 of FIG. 11). In this example implementation, the computing device (CPU) can be coupled, connected, and/or in communication with one or more peripheral devices, such as display. In another example implementation, the term computing device, as used herein, can refer to a mobile computing device such as a smartphone, tablet computer, or smart watch. In this example implementation, the computing device outputs content to its local display and/or speaker(s). In another example implementation, the computing device outputs content to an external display device (e.g., over Wi-Fi) such as a TV or an external computing system.

In example implementations of the disclosed technology, a computing device includes any number of hardware and/or software applications that are executable to facilitate any of the operations. In example implementations, one or more I/O interfaces facilitate communication between the computing device and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., can facilitate user interaction with the computing device. The one or more I/O interfaces can be utilized to receive or collect data and/or user instructions from a wide variety of input devices. Received data can be processed by one or more computer processors as desired in various implementations of the disclosed technology and/or stored in one or more memory devices.

One or more network interfaces can facilitate connection of the computing device inputs and outputs to one or more suitable networks and/or connections; for example, the connections that facilitate communication with any number of sensors associated with the system. The one or more network interfaces can further facilitate connection to one or more suitable networks; for example, a local area network, a wide area network, the Internet, a cellular network, a radio frequency network, a Bluetooth enabled network, a Wi-Fi enabled network, a satellite-based network any wired network, any wireless network, etc., for communication with external devices and/or systems.

Certain implementations of the disclosed technology are described above with reference to block and flow diagrams of systems and methods and/or computer program products according to example implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, implementations of the disclosed technology may provide for a computer program product, including a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology are described above with reference to mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, Internet tablets, PDAs, ultra-mobile PCs (UMPCs) and smartphones.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “one implementation,” “an implementation,” “example implementation,” “various implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system comprising:
at least one processor; and
at least one memory having stored thereon instructions that, when executed by the at least one processor, control the at least one processor to:
receive a video file;
pre-process the video file to provide a timestamped transcript;
sample across the timestamped transcript to generate a plurality of timestamped fragments;
analyze the plurality of timestamped fragments to identify a likelihood of each fragment containing a highlight;
extract, from the video file, a plurality of video clips corresponding to the fragments having a likelihood of containing a highlight greater than a threshold; and
compile the plurality of video clips to generate a highlight video of the video file.

2. The system of claim 1, wherein pre-processing the video file comprises transcribing the video file with punctuation and stemming the transcription.

3. The system of claim 1, wherein sampling across the timestamped transcript comprises sampling the timestamped transcript across minimum and maximum sentence count limits.

4. The system of claim 1, wherein sampling across the timestamped transcript comprises applying at least from among a neural network to fragment the timestamped transcript, smart text fragmentation, boundary identification, beam search fragmentation, and peak extraction.

5. The system of claim 1, wherein analyzing the plurality of timestamped fragments comprises applying a neural network to each timestamped fragment to generate respective likelihoods that each fragment contains a highlight.

6. The system of claim 5, where the neural network comprises a Long Short-term Memory model (LSTM) with attention.

7. The system of claim 1, wherein analyzing the plurality of timestamped fragments further comprises cross-checking the fragments against designated attributes for desired highlights and identifying as highlights fragments that both have a high likelihood of containing a highlight and correspond to the designated attributes.

8. The system of claim 7, wherein only fragments identified as having a high likelihood of each containing a highlight are cross-checked against designated attributes.

9. The system of claim 7, wherein only fragments cross-checked against designated attributes are analyzed to determine whether they have a high likelihood of each containing a highlight.

10. The system of claim 1, wherein extracting the plurality of video clips comprises:
constructing a superset of highlights by merging overlapping identified fragments; and
extracting the superset of highlights as the plurality of video clips.

11. The system of claim 1, wherein extracting the plurality of video clips comprises performing boundary detection within the identified fragments and extracting, from the video file, a plurality of video clips corresponding to the fragments without crossing detected boundaries.

12. The system of claim 1, wherein receiving the video file comprises retrieving the video file from a designated location.

13. The system of claim 1, wherein analyzing the plurality of timestamped fragments comprises converting words within the timestamped fragments into embeddings.

14. A method comprising:
pre-processing a video file to provide a timestamped transcript;
sampling across the timestamped transcript to generate a plurality of timestamped fragments;
analyzing the plurality of timestamped fragments to identify a likelihood of each fragment containing a highlight;
extracting, from the video file, a plurality of video clips corresponding to the fragments having a likelihood of containing a highlight greater than a threshold; and
compiling the plurality of video clips to generate a highlight video of the video file.

15. The method of claim 14, wherein pre-processing the video file comprises transcribing the video file with punctuation and stemming the transcription.

16. The method of claim 14, wherein sampling across the timestamped transcript comprises sampling the timestamped transcript across minimum and maximum sentence count limits.

17. The method of claim 14, wherein sampling across the timestamped transcript comprises applying at least from among a neural network to fragment the timestamped transcript, smart text fragmentation, boundary identification, beam search fragmentation, and peak extraction.

18. The method of claim 14, wherein analyzing the plurality of timestamped fragments comprises applying a neural network to each timestamped fragment to generate respective likelihoods that each fragment contains a highlight.

19. The method of claim 18, where the neural network comprises a Long Short-term Memory model (LSTM) with attention.

20. A non-transitory computer readable medium having stored thereon computer program code that, when executed by one or more processors, controls the one or more processors to execute a method comprising:
pre-processing a video file to provide a timestamped transcript;
sampling across the timestamped transcript to generate a plurality of timestamped fragments;
analyzing the plurality of timestamped fragments to identify a likelihood of each fragment containing a highlight;
extracting, from the video file, a plurality of video clips corresponding to the fragments having a likelihood of containing a highlight greater than a threshold; and
compiling the plurality of video clips to generate a highlight video of the video file.
